(19) United States
(12) Patent Application Publication
(10) Pub. No.: US 2010/0317479 A1
(43) Pub. Date: Dec. 16, 2010

(54) CHAINSET WITH INTERCHANGEABLE CHAINRINGS

(76) Inventor: Jean-Yves Delale, Lyon (FR)

Correspondence Address: DOWELL & DOWELL P.C., 103 Oronoco St., Suite 220, Alexandria, VA, 22314, US

(21) Appl. No.: 12/744,075

(22) PCT Filed: Nov. 24, 2008
(86) PCT No.: PCT/FR08/52112

§ 371 Date: Jul. 23, 2010

(30) Foreign Application Priority Data
Nov. 22, 2007 (FR) 07 56229
Nov. 22, 2007 (FR) 07 59230

(51) Int. Cl. B62M 9/10; B62M 9/02; F16H 37/02; B62M 3/00

(52) U.S. Cl. 475/213; 474/152; 474/160; 474/101

(57) ABSTRACT

Bicycle chainset comprising: two cranks (4,5) each comprising, at one end, means (7) for fastening a pedal, a main axle, of axis x-x′, coupled in rotation to the two cranks (4, 5) and intended to be fitted into a bottom bracket (3) of a bicycle frame (2), and at least one toothed chainring (8) rotated by the cranks (4,5). The chainset comprises, furthermore, universal adaptor means (15) for the chainring (8) that are rotated by the cranks (4,5) and that enable the chainring (8) to be positioned and removed by interlocking.

The present invention relates to the technical field of systems for driving bicycle wheels and more particularly the field of bicycle chainsets.

The chainsets of modern bicycles generally include a plurality of chainrings that, through their selective use, provide a plurality of gear ratio ranges. The chainrings are riveted to attachments that are secured to the cranks. Changing the chainrings therefore involves changing the length of those attachments as a function of the size (circumference) of the chainrings. This requires changing the complete chainset or at least changing the crank supporting the chainrings, with the result that it is necessary to have as many chainsets or cranks as there are combinations of chainrings necessary to provide the bicycle with gear ratios perfectly adapted to the conditions of use.

The requirement has therefore become apparent for a new type of chainset enabling all possible “chainring set” configurations to be obtained with the same pair of cranks or a “single chainset”.

In order to achieve this objective, the invention provides a bicycle chainset including:
two cranks each including at one end means for securing a pedal;
a main shaft on an axis X-X′ rotationally coupled to the two cranks and adapted to be fitted into a bottom bracket of a bicycle frame; and
at least one toothed chainring adapted to be rotated by the cranks.

According to the invention, the chainset is characterized in that it includes universal fitting means for the chainring that are rotated by the cranks and that enable the chainring to be fitted and removed by stacking.

The use of universal fitting means rotationally coupled to the cranks and stacking the chainrings on the universal fitting means make it possible to change the chainrings quickly, with the result that it is possible with the same chainset to obtain different gear ratio ranges simply by changing the chainrings. Moreover, the stackable nature of the chainrings makes it possible to envisage diverse combinations of chainring sizes. The chainset of the invention therefore has obvious practical and economic advantages when it comes to using the same bicycle under varied conditions.

The means for fitting one or more chainrings are referred to as universal in the sense that they are adapted to receive, firstly, chainrings of relatively large size, i.e. of the maximum size that is commonly used, namely of the order of 54 teeth, and, secondly, chainrings of relatively small size, i.e. of the smallest size that is commonly used, namely of the order of 22 teeth. By means of the universal fitting means, a chainset of the invention can receive, alternately or in a combination of two or three chainrings, chainrings throughout the range of sizes 22 teeth to 54 teeth, even in the range 14 teeth to 55 teeth, whereas, in the prior art, a plurality of chainsets is required to cover such a range of chainring sizes.

Thus, according to one feature of the invention, the universal fitting means are adapted to receive alternately and/or in combination a chainring of relatively small size comprising in the range 14 teeth to 31 teeth and a chainring of relatively large size comprising in the range 34 teeth to 55 teeth.

According to one feature of the invention, the universal fitting means include at least one secondary shaft coaxial with the main shaft.

The use of universal fitting means in the form of a secondary shaft coaxial with the main shaft makes it possible to simplify fitting even further, in that regardless of their size, the chainrings are stacked one after the other on the same secondary shaft.

In one embodiment of the invention the universal fitting means include a splined cylindrical secondary shaft on the axis X-X′, and each chainring has at its center a bore with a shape complementary to the shape of the secondary shaft so that the chainring and the secondary shaft are rotationally coupled.

According to one feature of the invention, the chainset includes at least one removable spacer disposed between the chainrings of each pair.

According to a further feature of the invention, the chainset includes at least two removable chainrings.

In a preferred but non-essential embodiment of the invention, the chainset includes a gear system disposed between the universal fitting means and the cranks to gear the rotation speed of the universal fitting means up or down relative to the rotation speed of the cranks.

Using such a gear system makes it possible, at constant gear ratio and in the situation of gearing up, to reduce the size of the chainrings and thus to increase the distance between the lower part of the largest chainring and the ground. Moreover, reducing the size of the chainrings makes it possible to reduce the chain length, thus contributing to overall weight reduction and more reliable gear changing. In the situation of gearing down, this gear system makes it possible to retain a sufficient size of the chainrings to provide good guidance of the chain.

According to a feature of this preferred embodiment the gear system is adapted to gear up the rotation speed of the cranks in a ratio preferably in the range 1.2 to 1.5.

According to another feature of this preferred embodiment the gear system is adapted to gear up the rotation speed of the cranks in a ratio in the range 1.25 to 1.45.

According to a further feature of this preferred embodiment, the chainset includes a relatively large chainring comprising at most 45 teeth and at least 25 teeth and a relatively small chainring comprising at least 16 teeth and at most 30 teeth.

In a variant of the preferred embodiment, the gear system is an epicyclic gear.

According to a feature of this variant, the chainset includes an interior sun gear, at least one planet gear with two sets of teeth supported by a planet gear carrier rotationally coupled to the cranks, and an exterior sun gear, the interior and exterior sun gears being respectively rotationally coupled to the universal fitting means of the chainrings and adapted to be rotationally coupled to the frame, or vice versa.

It is preferable, although not essential, for the exterior sun gear to be rotationally coupled to the universal fitting means of the chainrings, while the interior sun gear is adapted to be coupled to the frame.

According to one feature of the invention, the chainset includes a bell-shaped casing that is rotationally coupled to a crank, supports the planet gear carrier shaft and fits over an annular flange secured to the universal fitting means of the chainrings to define a housing for the epicyclic gear, the interior sun gear being carried by a sleeve coaxial with the shaft and adapted to be rotationally coupled to the frame.

To facilitate fitting and removing the chainset, a preferred embodiment thereof includes a counter-sleeve adapted to be fastened to the frame and including a cylinder for receiving the sleeve, which sleeve is removably fitted to the counter-sleeve.

According to one feature of the invention, aiming to provide the chainset with good stiffness, one of the cranks, the bell-shaped casing, and the main shaft together form a one-piece assembly, the other crank being adapted to be removably fitted to the main shaft.

According to the invention, the chainset may be made in various suitable materials. According to one feature of the invention, the cranks and the main shaft are produced in composite material containing carbon fibers.

Of course the various features, embodiments and variants of the invention can be associated with each other in various combinations provided that they are not mutually incompatible or exclusive.

Moreover, diverse other features of the invention emerge from the description given with reference to the appended drawings, which show a preferred but non-limiting embodiment of a chainset of the invention. In the drawings:

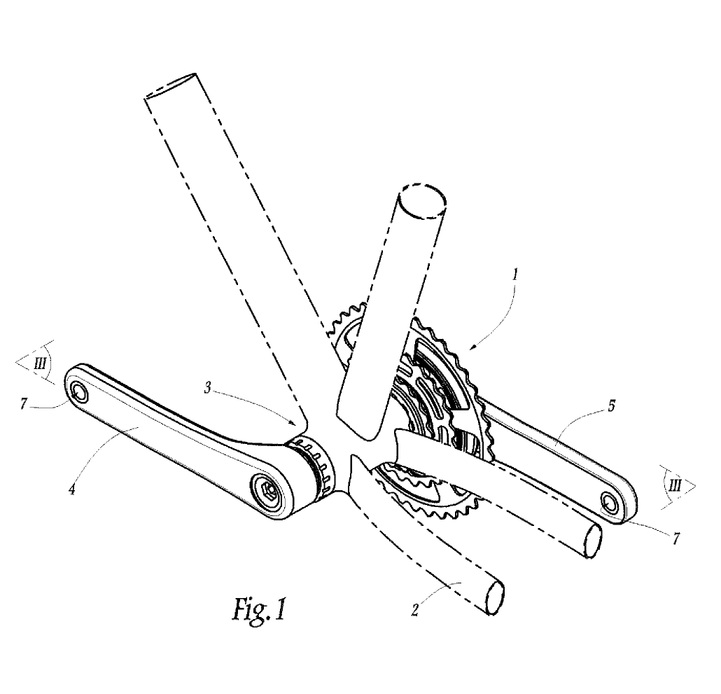

FIG. 1 is a partial perspective view of a chainset of the invention fitted to a bicycle frame of which only the part situated near the bottom bracket of the chainset is shown;

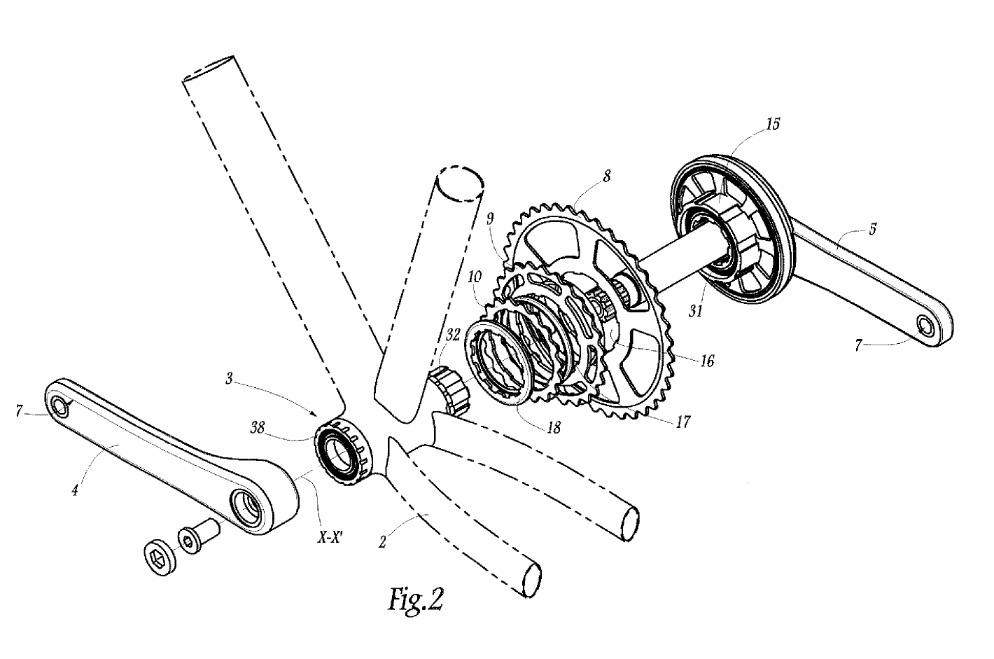

FIG. 2 is an exploded perspective view of the chainset shown in FIG. 1;

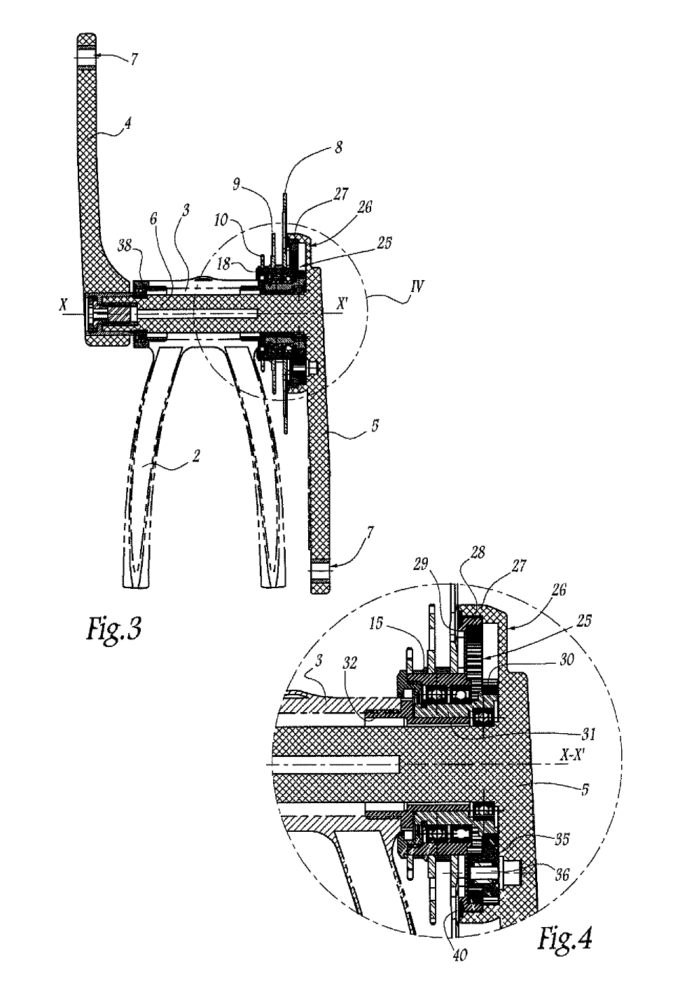

FIG. 3 is a view in axial section of the chainset shown in FIG. 1 taken along the line III-III; and

FIG. 4 is a view to a larger scale of the portion IV of FIG. 3.

A chainset 1 of the invention shown in FIGS. 1 to 4 is adapted to be removably fitted to a bicycle frame 2 at the level of a housing 3 called the bottom bracket in the lower part of the frame. The chainset 1 includes two cranks, respectively a left crank 4 and a right crank 5, which are joined to each other by a main shaft 6. In the example shown, the left crank 4 is removably coupled to the shaft 6, which is secured to the right crank 5 with which it forms a one-piece assembly. It is therefore possible to separate the chainset from the frame 2 by removing the left crank 4. Of course, both the cranks 4 and 5 could just as well be removably fastened to the shaft 6. The cranks 4 and 5 have at their ends remote from the main shaft 6, respective means 7 for fastening a pedal, not shown. In the example shown, the fastening means are in the form of a bore 7 for receiving a pedal or a pedal shaft.

The chainset 1 further includes universal fitting means for three removable chainrings 8, 9, and 10 in the form of a secondary shaft 15 driven in rotation by the cranks 4 and 5. In the example shown, the secondary shaft 15 has the general shape of a circular cylinder coaxial with the main shaft 6 and therefore sharing therewith the rotation axis X-X′ of the cranks. In the example shown, the secondary shaft 15 is produced in the form of a splined shaft for rotationally coupling the chainrings 8 to 10. Accordingly, each of the chainrings 8 to 10 has at its center a bore 16 of shape complementary to the shape of the shaft 15. The chainrings 8 to 10 are thus mounted simply by stacking the chainrings on the secondary shaft 15 with a removable spacer 17 between the chainrings of each pair. Axial locking of the chainrings is then achieved by means of a ring 18 fastened to the secondary shaft 15. It is thus particularly easy to replace one or the other of the chainrings simply by removing the right crank and the ring 18. It is then possible to use chainrings of different sizes to produce different combinations of chainrings for the same chainset by varying the number and/or the size of the chainrings.

Thus a set of chainrings may be used including at least four chainrings, for example:
a relatively large chainring comprising in the range 49 teeth to 54 teeth;
a first intermediate chainring comprising in the range 44 teeth to 48 teeth;
a second intermediate chainring comprising in the range 37 teeth to 43 teeth; and
a relatively small chainring comprising in the range 22 teeth to 36 teeth.

The chainrings may then be used alternately or in combinations of two or three chainrings, for example. Spacers of different sizes may be used to ensure proper axial locking of the chainring or each of the chainrings mounted on the universal fitting means 15.

According to the invention, the secondary shaft 15, and thus the chainrings 8 to 10, may be driven in rotation by a direct connection between the cranks and the secondary shaft 15, one turn of a crank corresponding to one turn of the secondary shaft, or drive may pass via a gear system. In the example shown, a gear system 25 is used formed by an epicyclic gear for gearing up the rotation speed of the cranks 4 and 5 in a ratio in the range 1.2 to 1.5 and preferably in the range 1.25 to 1.45.

In the example shown, in order to ensure proper protection of the epicyclic gear 25, the right crank 5 supports a bell-shaped casing 26 with which it forms a one-piece assembly. The bell-shaped casing 26 is closed on the side oriented toward the right crank 5 and open on the opposite side. The bell-shaped casing 26 has a peripheral edge 27 that fits over a peripheral rim 28 of the secondary shaft 15. The peripheral rim 28 carries an exterior sun gear 29. The casing 26 forms with the annular disk 28 a closed space inside which there is also an interior sun gear 30 secured to a sleeve 31 fitted over a counter-sleeve 32 connected to the bottom bracket so that the interior sun gear 30 is rotationally coupled to the frame 2. The epicyclic gear 25 finally includes at least one planet gear, three of them in the example shown, of which only one planet gear 35 is visible. Each planet gear 35 is carried by an shaft 36 secured to the bell-shaped casing 26 and parallel to the axis X-X′. Each planet gear 35 comprises two sets of teeth, a first of which is adapted to cooperate with the interior sun gear 30 and a second of which is intended to cooperate with the exterior sun gear 29. According to the invention, the dimensions of the interior and exterior sun gears and those of the planet gears 35 are chosen so that the epicyclic gear 25 gears up the rotation of the cranks so that one turn of the cranks rotates the universal fitting means 15 by more than one turn.

If such a gear system is used, the chainset of the invention can be associated with a set of chainrings including at least four chainrings, for example:
a relatively large chainring comprising in the range 34 teeth to 38 teeth;
a first intermediate chainring comprising in the range 30 teeth to 33 teeth;
a second intermediate chainring comprising in the range 25 teeth to 29 teeth; and
a relatively small chainring comprising in the range 15 teeth to 24 teeth.

As stated above, the chainrings can then be used alternately or in combinations of two or three chainrings, for example. Spacers of different sizes ensure proper axial locking of the chainring or chainrings mounted on the universal fitting means 15.

It should be noted that in the example shown the surface on the counter-sleeve 32 for receiving the sleeve 31 forms a splined shaft intended to cooperate with the complementary shape of the internal bore of the sleeve 31. This shape facilitates fitting and removing the chainset. In this regard, it should also be noted that the bearing guiding rotation of the main shaft 6 at the level of the right crank 5 is disposed between the sleeve 31 and the shaft 6. On the left-hand side the bearing for guiding rotation of the main shaft 6 is carried by a ring 38 fastened to the bottom bracket 3 and inside which the main shaft 6 is engaged. Thus it is easy to fit and remove the chainset. It may also be noted that the conformation of the casing 26 and the annular disk 28 make it possible to define a space for receiving the epicyclic gear that is relatively well protected from splashes, and that to improve the sealing of this space against splashes a lip seal 40 may be provided either on the annular rim 28 or on the peripheral rim 27.

According to the invention, the components of the chainset may be produced in any appropriate materials. In a preferred embodiment, at least the cranks 4, 5, the main shaft 6 and the bell-shaped casing 26 are produced in carbon-fiber-reinforced composite materials. It may further be noted that in the example shown the main shaft 6, the crank 5 and the bell-shaped casing 26 form a one-piece assembly. Producing all the components of the chainset in metal could be envisaged, of course, the cranks, the main shaft, and the casing being produced in metal or light alloy, such as aluminum or aluminum alloy.

It should finally be noted that is not always necessary to use a transmission gear between the cranks and the chainrings to produce a chainset of the invention.

Of course various modifications within the scope of the claims may be made to the chainset of the invention.

1-19. (canceled)

20. A bicycle chainset including:
two cranks each including at one end means for securing a pedal;
a main shaft on an axis X-X′ rotationally coupled to the two cranks and adapted to be fitted into a bottom bracket of a bicycle frame; and
at least one toothed chainring adapted to be rotated by the cranks;
which chainset is characterized in that it includes universal fitting means for the chainring that are rotated by the cranks and that enable the chainring to be fitted and removed by stacking.

21. A chainset according to claim 20, characterized in that the universal fitting means are adapted to receive alternately and/or in combination a chainring of relatively small size comprising in the range 14 teeth to 31 teeth and a chainring of relatively large size comprising in the range 34 teeth to 55 teeth.

22. A chainset according to claim 20, characterized in that the universal fitting means include at least one secondary shaft coaxial with the main shaft and each chainring has at its center a bore with a shape complementary to that of the secondary shaft so that the chainring and the secondary shaft are rotationally cupled.

23. A chainset according to claim 20, characterized in that the universal fitting means include a splined cylindrical secondary shaft on the axis X-X′ and each chainring has at its center a bore with a shape complementary to the shape of the secondary shaft so as to couple in rotation the chainring and the secondary shaft.

24. A chainset according to claim 20, characterized in that it includes at least one removable spacer disposed between the chainrings of each pair.

25. A chainset according to claim 20, characterized in that it includes at least two removable chainrings.

26. A chainset according to claim 20, characterized in that it includes a gear system disposed between the universal fitting means and the cranks to gear the rotation speed of the universal fitting means up or down relative to the rotation speed of the cranks.

27. A chainset according to claim 26, characterized in that the gear system is adapted to gear up the rotation speed of the cranks in a ratio greater than 1 and preferably in the range 1.2 to 1.5.

28. A chainset according to claim 27, characterized in that the gear system is adapted to gear up the rotation speed of the cranks in a ratio in the range 1.25 to 1.45.

29. A chainset according to claim 26, characterized in that it includes a relatively large chainring comprising at most 45 teeth and at least 25 teeth and a relatively small chainring comprising at least 16 teeth and at most 30 teeth.

30. A chainset according to claim 26, characterized in that the gear system is an epicyclic gear.

31. A chainset according to claim 30, characterized in that it includes an interior sun gear, at least one planet gear with two sets of teeth supported by a planet gear carrier rotationally coupled to the cranks, and an exterior sun gear, the interior and exterior sun gears being respectively rotationally coupled to the universal fitting means of the chainrings and adapted to be rotationally coupled to the frame, or vice versa.

32. A chainset according to claim 31, characterized in that the exterior sun gear is rotationally coupled to the universal fitting means of the chainrings while the interior sun gear is adapted to be coupled to the frame.

33. A chainset according to claim 32, characterized in that it includes a bell-shaped casing that is rotationally coupled to a crank, supports the planet gear carrier shaft and fits over an annular flange secured to the universal fitting means of the chainrings to define a housing for the epicyclic gear, the interior sun gear being carried by a sleeve coaxial with the main shaft and adapted to be rotationally coupled to the frame.

34. A chainset according to claim 33, characterized in that it includes a counter-sleeve adapted to be fastened to the frame and including a cylinder for receiving the sleeve, which is removably fitted to the counter-sleeve.

35. A chainset according to claim 33, characterized in that one crank, the bell-shaped casing and the main shaft form a one-piece assembly, the other crank being adapted to be removably fitted to the main shaft.

36. A chainset according to claim 20, characterized in that the cranks and the main shaft are produced in composite material containing carbon fibers.

37. An assembly formed firstly of a chainset according to claim 20, wherein the universal fitting means are adapted to receive at least two chainrings simultaneously, and secondly of a set of chainrings independent of each other and adapted to be removably fitted alternately and/or in combinations of two or three to the universal fitting means of the chainset, the set of independent chainrings including at least:
a relatively large chainring comprising in the range 49 teeth to 54 teeth;
a first intermediate chainring comprising in the range 44 teeth to 48 teeth;
a second intermediate chainring comprising in the range 37 teeth to 43 teeth; and
a relatively small chainring comprising in the range 22 teeth to 36 teeth.

38. An assembly formed firstly of a chainset according to claim 26, wherein the universal fitting means are adapted to receive at least two chainrings simultaneously, and secondly of a set of chainrings independent of each other and adapted to be removably fitted alternately and/or in combinations of two or three to the universal fitting means of the chainset, the set of independent chainrings including at least:
relatively large chainring comprising in the range 34 teeth to 38 teeth;
a first intermediate chainring comprising in the range 30 teeth to 33 teeth;
a second intermediate chainring comprising in the range 25 teeth to 29 teeth; and
a relatively small chainring comprising in the range 15 teeth to 24 teeth.
